(19) United States
(12) Patent Application Publication
(10) Pub. No.: US 2023/0102545 A1
(43) Pub. Date: Mar. 30, 2023

(54) DRIVE ASSEMBLY FOR THE MOTORISED ADJUSTMENT OF AN ADJUSTING ELEMENT OF A MOTOR VEHICLE

(71) Applicant: Brose Fahrzeugteile SE & Co. Kommanditgesellschaft, Bamberg, Bamberg (DE)

(72) Inventors: Melanie ANGERMÜLLER, Heldburg (DE); Nils HANNEMANN, Hallstadt (DE); Daniel SCHNAPP, Ebensfeld (DE); Johannes BARTOSCHEK, Bamberg (DE); Lars KLIMENTEW, Haßfurt (DE)

(73) Assignee: Brose Fahrzeugteile SE & Co. Kommanditgesellschaft, Bamberg, Bamberg (DE)

(21) Appl. No.: 17/800,577

(22) PCT Filed: Feb. 16, 2021
(86) PCT No.: PCT/EP2021/053692

§ 371 Date: Aug. 18, 2022

(30) Foreign Application Priority Data
Feb. 18, 2020 (DE) 10 2020 104 204.3

(51) Int. Cl. E05F 15/614; E05F 15/622

(52) U.S. Cl. CPC E05F 15/614; E05F 15/622

(57) ABSTRACT

A drive assembly for motorized adjustment of an adjusting element of a motor vehicle. The drive assembly includes a drive having a rotational motor unit and a feed gearing drivingly arranged downstream of the motor unit for generating drive movements along a feed gearing axis in first and second adjusting directions, the drive includes a clutch having a first clutch element, rotationally fixed to a driveshaft of the drive, and a second clutch element, rotationally fixed to an output shaft of the drive, in a state in which they are drivingly coupled to one another, the clutch elements transmit rotational movements from the driveshaft to the output shaft, to generate the drive movements of the feed gearing. The clutch is designed as a curved tooth coupling.

### CROSS-REFERENCE TO RELATED APPLICATIONS

This application is the U.S. National Phase of PCT Application No. PCT/EP2021/053692 filed on Feb. 16, 2021, which claims priority to German Patent Application No. DE 10 2020 104 204.3, filed on Feb. 18, 2020, the disclosures of which are hereby incorporated in their entirety by reference herein.

### TECHNICAL FIELD

The present disclosure relates to a drive arrangement for the motorized adjustment of an adjusting element.

### BACKGROUND

Within the context of increasing the comfort in motor vehicles, the motorized adjustment of adjusting elements is given special significance. An adjusting element can be a closing element, for example a side door. Other types of closing elements are, for example, trunk lids, front hoods, tailgates or the like. An adjusting element can also, however, be an adjustable seat part such as a backrest or the like.

### SUMMARY

The present disclosure is based on one or more problems such as configuring and developing a drive arrangement in such a way that installation and component tolerances can be compensated in a manner that is simple and neutral in terms of installation space.

According to one or more embodiments, a drive arrangement provided with a drive shaft and an output shaft is provided. Coupling the drive shaft and the output shaft to one another in drive terms via a coupling, the coupling elements of which can be tilted relative to one another in that state of the coupling, in which it is plugged together but is not yet finally assembled. During the final assembly, in the case of which the drive and output shaft are fastened as intended, the coupling elements are aligned in an optimum manner with respect to one another by way of tilting. “Tiltable” or “tilting” means a movability of the coupling element here about an axis which runs orthogonally with respect to the rotational axis of the coupling element. Movements stiffnesses are prevented as a result, and the development of noise during operation is reduced considerably.

In one or more embodiments, the coupling is configured as a curved tooth coupling. A curved tooth coupling is a coupling with two or more toothed coupling elements which are coupled to one another in drive terms. Here, depending on the coupling variant (single-sided or two-sided curved tooth coupling), one or two coupling elements are configured as a gearwheel or shaft end portion with an external toothing system which can be rotated in each case about a geometric rotational axis, the radially outwardly pointing tooth tip surface of the teeth being curved in each case about an axis which is orthogonal with respect to the rotational axis, that is to say is convex over the tooth width. The right-hand and/or left-hand tooth flank of the teeth can also be curved in each case about an axis which is orthogonal with respect to the rotational axis, that is to say the tooth flank or flank line can be convex over the tooth width. The gear wheel or the externally toothed shaft end portion is therefore convex on the tip surface and, as an example, also on the respective tooth flank, but can also be conical, at any rate in sections. If the respective coupling element is inserted as intended during the assembly into a corresponding internally toothed counterpart, for example a shaft attachment or an internal gear, the respective externally toothed coupling element can be fastened in a tilted manner relative to the internally toothed coupling element on account of the convex and possibly conical shape, if the installation and component tolerances should require this.

In the case of a single-sided curved tooth coupling, in the case of which a drive-side and output-side coupling element is therefore coupled to an output-side and a drive-side internally toothed coupling element, respectively, at least an angular offset between the drive shaft and the output shaft can be compensated for as a result. In the case of a two-sided curved tooth coupling, in the case of which a drive-side externally to coupling element is coupled to an internally toothed internal gear as coupling element which is in turn coupled to an output-side externally toothed coupling element, an axial offset between the drive shaft and the output shaft can also be compensated for, in addition to an angular offset, the former by virtue of the fact that the two externally toothed coupling elements can be tilted in the internally toothed internal gear in such a way that the rotational axes of the drive shaft and output shaft can run parallel to one another. The compensation of a length offset is fundamentally also possible in a simple way by way of a coupling of this type.

As an alternative, the coupling can be configured with two combined single-sided curved tooth couplings, in the case of which a drive-side internally toothed coupling element with an externally tooth coupling element is therefore coupled via an additional shaft to an output-side internally toothed coupling element with an externally toothed coupling element. Here, the two externally toothed coupling elements are fixed at in each case one end of the additional shaft, and transmit the drive movement from the drive shaft to the output shaft.

One or more embodiments relate to the curved tooth coupling, namely firstly the single-sided curved tooth coupling and secondly the double-sided curved tooth coupling.

According to one or more embodiments, the first coupling element is externally toothed and the second coupling element is internally toothed, or vice-versa.

According to one or more embodiments, the internally toothed coupling element is formed by an internally toothed internal gear, an internally toothed shaft attachment disposed on at least one of the drive shaft and the output shaft, or an internally toothed hollow shaft-shaped shaft end portion of at least one of the drive shaft and the output shaft. According to yet another embodiment, the first coupling element and the second coupling element may each be externally toothed and at least one of the first and second coupling elements may be formed of metal or plastic material

According to one or more embodiments cross-sectional shapes of the coupling elements, the cross section always relating to an axial section here, is provided. That is to say a section in a plane, in which the rotational axis of the respective coupling element also runs.

According to one or more embodiments, if the advancing mechanism of the drive arrangement according to the proposal is a spindle/spindle nut mechanism, the output shaft may be the spindle of the spindle/spindle nut mechanism. A worm gear stage can also be provided in the drive arrangement, the output shaft then preferably supporting the worm.

According to one or more embodiments, the drive includes a drive housing that may be configured to receive the motor unit and/or the advancing mechanism and/or one or more coupling elements.

According to yet another embodiment, and the adjusting element arrangement with an adjusting element, as an example a closing element, of a motor vehicle and with a drive arrangement according to the proposal as described herein. To this extent, reference may be made to all the comments in respect of the drive arrangement according to the proposal.

### BRIEF DESCRIPTION OF THE DRAWINGS

In the following text, the invention will be explained in greater detail on the basis of the drawing which illustrates merely exemplary embodiments, and in which:

FIG. 1 shows the rear region of a motor vehicle with an adjusting element arrangement according to the proposal which is equipped with a drive arrangement according to the proposal,

FIG. 2 shows the drive arrangement according to FIG. 1 in a partial illustration,

FIG. 3 shows the drive arrangement according to FIG. 1 in a perspective view with an enlargement of a detail,

FIG. 4 shows a sectional view of a part of the drive arrangement according to FIG. 1,

FIG. 5 shows sectional views of a first exemplary embodiment of a coupling of the drive arrangement according to FIG. 1 in the installed state a) with a coaxial axial alignment, b) with an axial offset and c) with an angular offset, and

FIG. 6 shows sectional views of a second exemplary embodiment of a coupling of the drive arrangement according to FIG. 1 in the installed state a) with a coaxial axial alignment and b) with an angular offset.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known drive arrangement, described in DE 10 2017 115 464 A1, serves for the motorized adjustment of a closing element in the form of a tailgate of a motor vehicle. The drive arrangement has a drive unit with a drive which has a rotational motor unit and an advancing mechanism which is connected downstream in drive terms of the motor unit for generating linear drive movements for opening and closing of the closing element. Here, the advancing mechanism as a spindle/spindle nut mechanism with a spindle and a spindle nut which meshes with it. Furthermore, the drive of this drive arrangement has a claw coupling with two coupling elements, of which one coupling element is connected to a drive shaft and the other coupling element is connected to an output shaft of the drive. Here, the drive shaft is a gear mechanism output shaft of an intermediate gear mechanism of the motor unit, which intermediate gear mechanism couples the gear mechanism output shaft in drive terms to the motor shaft. Here, the output shaft is the spindle of the spindle/spindle nut mechanism.

In the assembled state, an angular offset and/or an axial offset (parallel offset) between the drive shaft and the output shaft can occur as a result of installation and component tolerances. This leads to movements stiffnesses, an undesired development of noise and increased loads within the drive arrangement. In the case of a conventional claw coupling, the coupling elements, that is to say the drive claw and the output claw, consist of a comparatively rigid material, for example of metal or hard plastic, and are therefore only capable to a limited extent of compensating for said installation and component tolerances.

The drive arrangement 1 according to the proposal serves for the motorized adjustment of an adjusting element 2 (here, a closing element) of a motor vehicle. The adjusting element 2 can be adjusted by means of the drive arrangement 1 in a first adjusting direction (here, an opening direction) and in a second adjusting direction (here, a closing direction).

Here, purely by way of example, the adjusting element 2 in the form of the closing element is a trunk lid of the motor vehicle. The drive arrangement 1 according to the proposal can also fundamentally be applied with the same advantages, however, to different types of adjusting elements, as an example closing elements, of a motor vehicle. These include, inter alia, tailgates, rear doors, front hoods and side doors of the motor vehicle. Reference is to be made to the list in the introductory part of the description with regard to further advantageous adjusting elements.

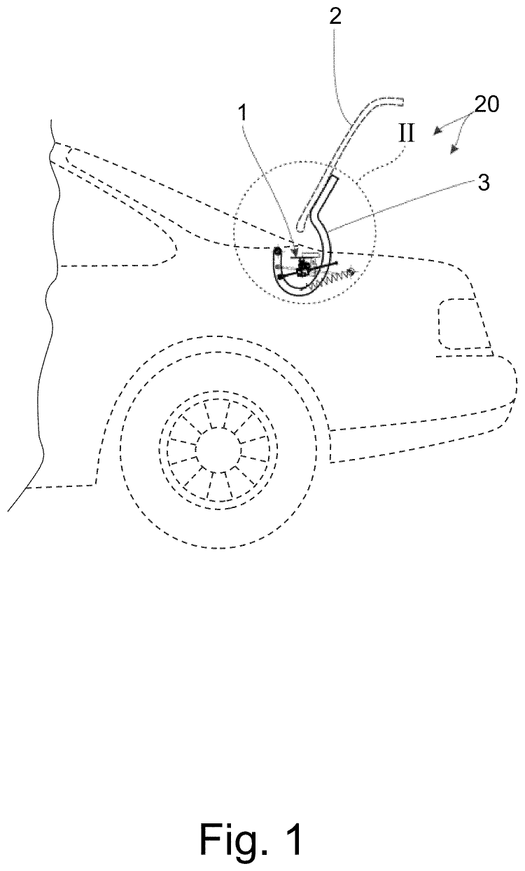

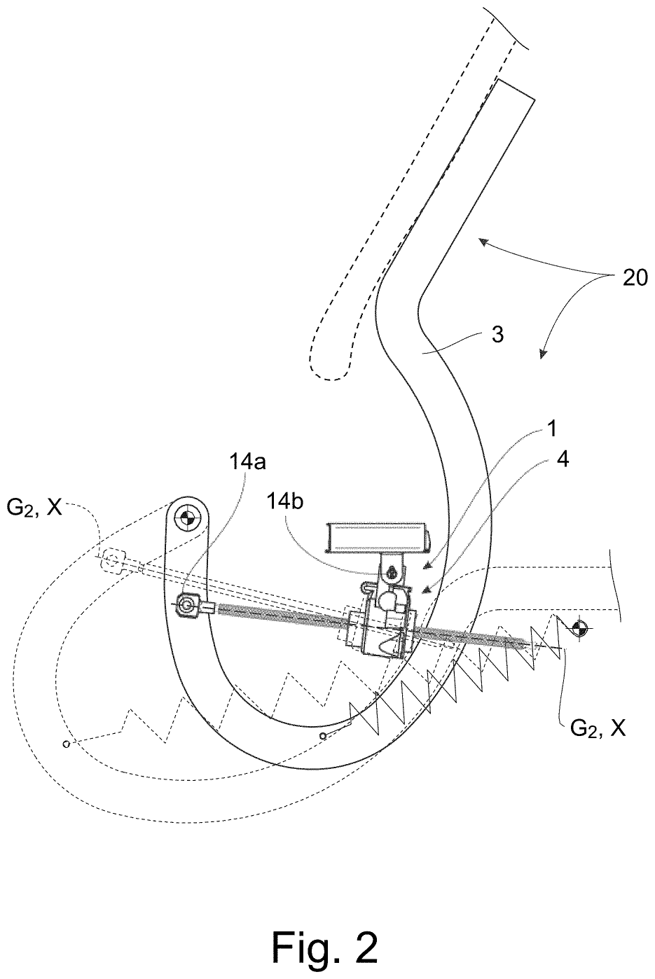

Viewing FIGS. 1 and 2 together shows that, in the assembled state here, the drive arrangement 1 acts, for example, on a motion link 3 which is assigned to the adjusting element 2. The drive arrangement 1 can fundamentally also act directly on the adjusting element 2.

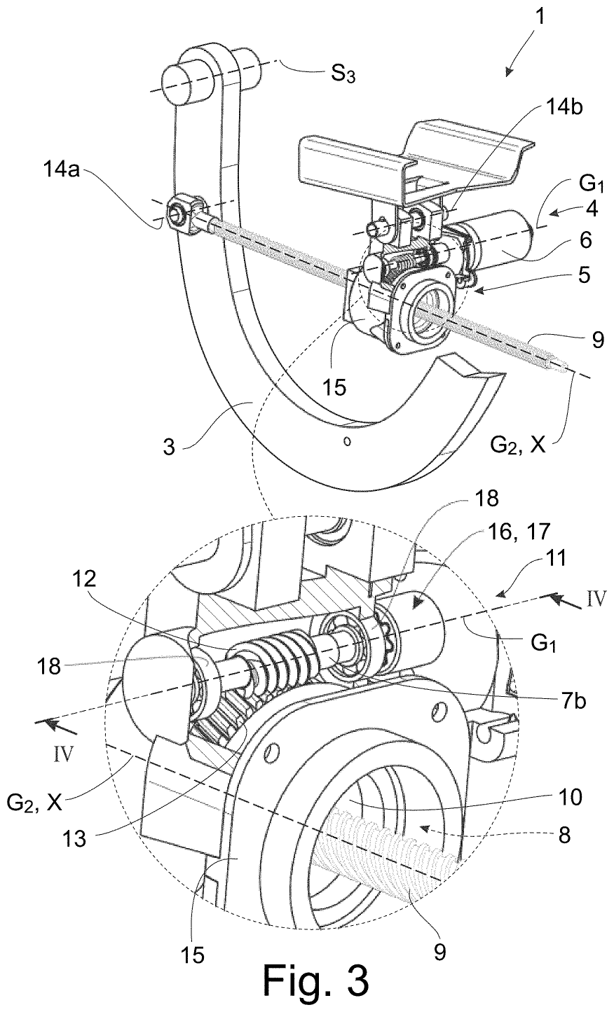

The drive arrangement 1 has a drive unit 4 with a drive 5. The drive 5 per se is shown on an enlarged scale in the perspective illustration according to FIG. 3. In one or more embodiments, the adjusting element 2 is assigned only a single drive unit 4. The adjusting element 2 can fundamentally also be assigned two drive units 4, however, which can be arranged on the two opposite sides of the motor vehicle trunk in the case of the exemplary embodiment which is shown here. The two drive units 4 are then preferably of identical or mirror-inverted configuration with respect to one another.

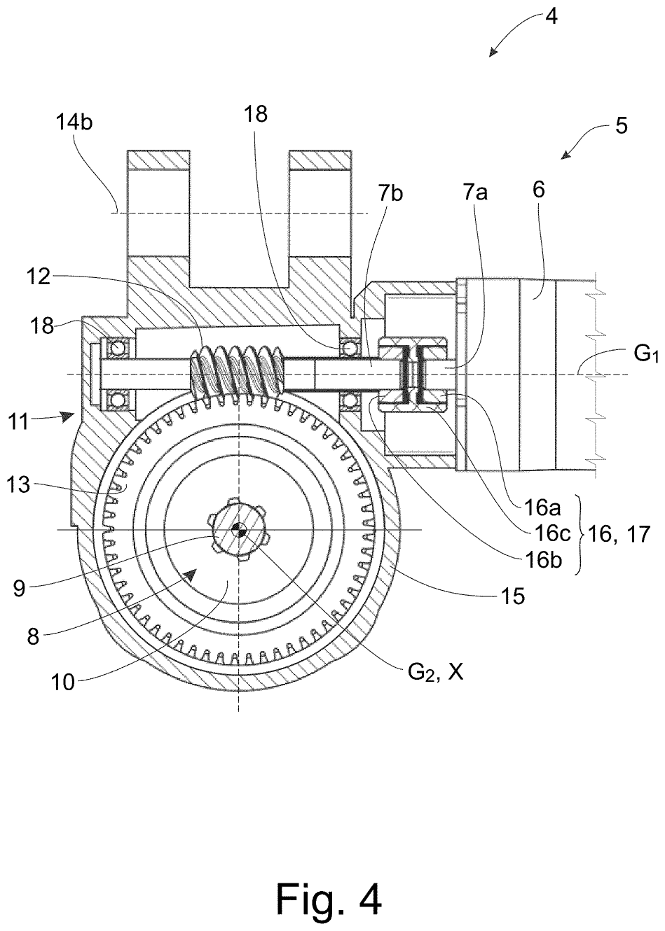

FIGS. 3 and 4 show that the drive 5 has a rotational motor unit 6 with an output shaft 7b. In the present case, the term “rotational” means that the motor unit 6 outputs drive movements via the output shaft 7b.

FIG. 3 shows, moreover, that an advancing mechanism 8 (here, in the form of a spindle/spindle nut mechanism) for generating drive movements along a geometric advancing mechanism axis X in a first adjusting direction which corresponds, as an example, to opening of the closing element and in a second adjusting direction which corresponds, as an example, to closing of the closing element is connected downstream of the motor unit 6. The spindle/spindle nut mechanism has a spindle 9 which meshes with a spindle nut 10 in a way which is routine per se. Here, the motor unit 6 is coupled in drive terms to the spindle nut 10 and transmits a torque to the latter, the spindle nut 10 then in turn setting the spindle 9 in linear movements.

Furthermore, FIGS. 3 and 4 show merely by way of example a worm gear stage 11 which is connected in drive terms here between the motor unit 6 and the advancing mechanism 8. The worm gear stage 11 has a worm 12 (here, a worm 12 which is coupled to the output shaft 7b of the motor unit 6) and a worm gear 13 which meshes with the worm 12 in a way which is likewise routine per se. This worm gear 13 forms a common component with the spindle nut 10 here, but can also be coupled in drive terms to the spindle nut 10. Here, the worm 12 can be rotated about a first gear axis G₁ and the worm gear 13 which meshes with it can be rotated about a second gear axis G₂ which runs transversely and, as an example, orthogonally with respect to the first gear axis G₁.

The motor unit 6, the optional worm gear stage 11 and the advancing mechanism 8 are arranged on a drive train of the drive arrangement 1, which drive train serves for the transmission of torque from the motor unit 6 to the spindle 9 which can be moved in a linear manner as a result and in this way moves two drive connectors 14a, 14b of the drive arrangement 1 relative to one another. The one drive connector 14a connects the spindle 9 pivotably to the adjusting element 2 or, as in the present exemplary embodiment, to the motion link 3 which is assigned to the adjusting element 2, whereas the other drive connector 14b otherwise connects the drive unit 4 pivotably to the motor vehicle, as an example via a drive housing 15 of the drive 5. In the present case, the term “drive housing” is to be understood broadly and also quite generally comprises a carrier which supports the motor unit 6 and/or the advancing mechanism 8. A drive housing 15 of this type does not necessarily have to be completely closed here.

Furthermore, as shown in FIGS. 4 to 6, the drive 5 has a coupling 16 with at least two coupling elements 16a, 16b, 16c, of which a first coupling element 16a is connected fixedly to a drive shaft 7a of the drive 5 for conjoint rotation and a second coupling element 16b is connected fixedly to an output shaft 7b of the drive 5 for conjoint rotation.

In one or more embodiments, the drive shaft 7a is the motor shaft and, as an example, the drive shaft 7b may be the abovementioned output shaft which introduces the rotational movements into the advancing mechanism 8.

In the state in which they are coupled to one another in drive terms, the at least two coupling elements 16a, 16b, 16c transmit rotational movements from the drive shaft 7a to the output shaft 7b which brings about the drive movements of the advancing mechanism 8.

In one or more embodiments, the coupling 16may be configured as a curved tooth coupling 17. A curved tooth coupling 17 has the advantage that it can compensate for an angular offset and possibly also an axial offset, and also a length offset, between the drive shaft 7a and the output shaft 7b or their rotational axes. This permits simplified assembly and the compensation of tolerances due to manufacture and assembly.

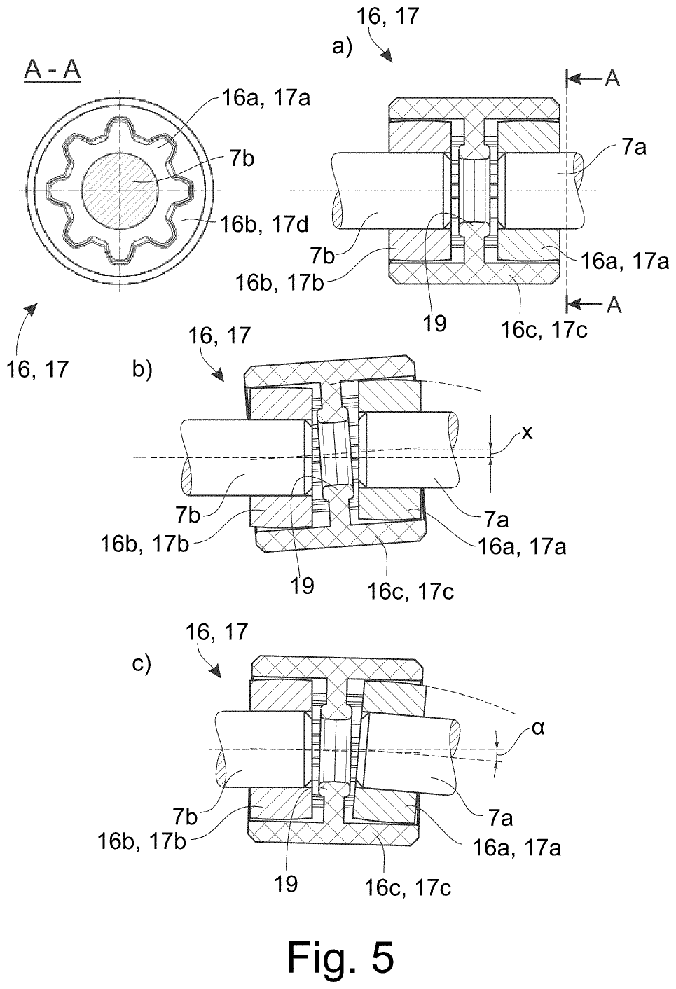

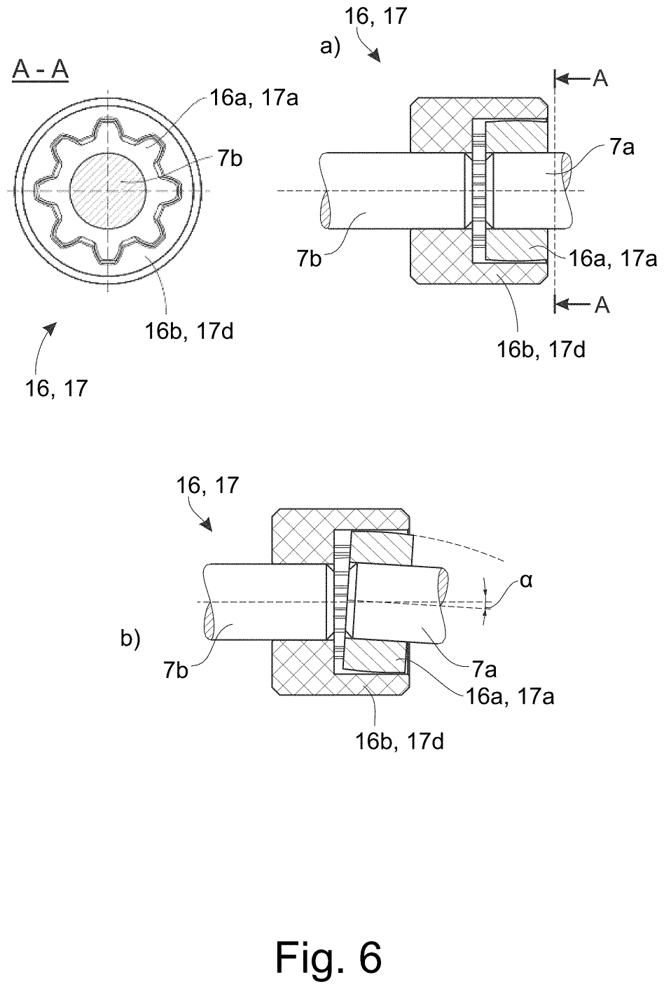

In the following text, the curved tooth coupling 17 is to be described in greater detail on the basis of two variants. FIG. 5 thus shows a two-sided curved tooth coupling 17, and FIG. 6 shows a single-sided curved tooth coupling 17.

A “two-sided” curved tooth coupling is a coupling 16 which has three coupling elements 16a, 16b, 16c. In one or more embodiments, the first coupling element 16a and the second coupling element 16b are in each case externally toothed, and a third coupling element 16c of the coupling 16 is internally toothed. As FIG. 5 shows, the first externally toothed coupling element 16a is provided on the drive shaft 7a, and the second externally toothed coupling element 16b is provided on the output shaft 7b. As FIG. 5 shows, furthermore, the third coupling element 16c is in (in the assembled state) or comes into (during operation) torque-transmitting engagement with the first coupling element 16a firstly and with the second coupling element 16b secondly. The third coupling element 16c is then an internally toothed connecting piece which receives the two externally toothed coupling elements 16a, 16b radially on the inner side and couples them to one another in drive terms.

“Couples in drive terms” means that, in the assembled state during operation, that is to say in the case of actuation of the drive arrangement 1 in the assembled state, the internal toothing is in engagement with the external toothing.

A “single-sided” curved tooth coupling is a coupling 16 which has only two coupling elements 16a, 16b, of which one is provided on the drive shaft 7a and the other is provided on the output shaft 7b. The one coupling element (here, the first coupling element 16a) is then externally toothed, and the other coupling element (here, the second coupling element 16b) is internally toothed. The reversed case is also conceivable, in the case of which the second coupling element 16b is externally toothed and the first coupling element 16a is internally toothed. As FIG. 6 shows, the first coupling element 16a is in (in the assembled state) or comes into (during operation) torque-transmitting engagement with the second coupling element 16b. The externally toothed coupling element 16a is then arranged radially within the internally toothed coupling element 16b and is coupled to the latter in drive terms.

In one or more embodiments, furthermore, it is provided in the case of the two-sided curved tooth coupling 17 in FIG. 5 that, of the two externally toothed coupling elements 16a, 16b, at least one or, as here, both is or are configured as a gearwheel 17a, 17b on the respective shaft 7a, 7b. In one or more embodiments, the gearwheel 17a, 17b may be configured as a spur gear, as an example a straight-toothed spur gear. The gearwheel 17a, 17b is fixed on the shaft so as to rotate with it and, as an example, is fixed axially. As an alternative, at least one or both externally tooth coupling elements 16a, 16b can also be configured as an externally toothed shaft end portion of the respective shaft 7a, 7b, preferably a spur-toothed and, as an example, straight-toothed shaft portion of the respective shaft 7a, 7b.

In the case of a single-sided curved tooth coupling 17, it can also be provided that the externally toothed coupling element 16a, 16b is configured as a gearwheel 17a, 17b, preferably as a spur gear and, as an example, a straight-toothed spur gear, on the respective shaft 7a, 7b or as an externally toothed shaft end portion of the respective shaft 7a, 7b, preferably as a spur-toothed and, as an example, straight-toothed shaft portion of the respective shaft 7a, 7b. The gearwheel 17a, 17b is fixed on the shaft so as to rotate with it and, as an example, is fixed axially. According to FIG. 6, the externally toothed coupling element 16a is configured by way of example as a gearwheel 17a on the drive shaft 7a (here, as a straight-toothed spur gear).

In one or more embodiments, it is provided in the case of the two-sided curved tooth coupling 17 in FIG. 5, moreover, that the internally toothed coupling element 16c is configured as an internally toothed internal gear 17c, preferably as a spur-toothed and, as an example, straight-toothed internal gear 17c which radially surrounds the two externally toothed coupling elements 16a, 16b. In one or more embodiments, the internal gear 17c has, radially on the inner side, a circumferential inner collar 19 which forms a stop during the assembly and defines the maximum push-in depth of the two shafts 7a, 7b during the assembly.

In the case of a single-sided curved tooth coupling 17, it can also be provided that the internally toothed coupling element 16a, 16b is configured as an internally toothed shaft attachment 17d on the respective shaft 7a, 7b or as an internally toothed hollow shaft-shaped shaft end portion of the respective shaft 7a, 7b. The shaft attachment 17d is fixed on the shaft so as to rotate with it and, as an example, is fixed axially. An internally toothed shaft attachment 17d, as is also shown by way of example in FIG. 6, may be a component which projects axially in sections beyond the shaft end of the respective shaft 7a, 7b and is internally toothed, preferably spur-toothed and, as an example, straight-toothed, in the projecting portion. An internally toothed hollow shaft-shaped shaft end portion may be likewise spur-toothed and, as an example, straight-toothed. According to FIG. 6, the internally toothed coupling element 16b is configured by way of example as a shaft attachment 17d on the output shaft 7b, which shaft attachment 17d is spur-toothed and straight-toothed here in the axially projecting portion which receives the externally to the coupling element 7a radially on the inner side.

Individual components of the coupling 16, preferably at least one externally toothed coupling element 16a, 16b, as an example both externally toothed coupling elements 16a, 16b, are preferably configured from metal, but can fundamentally also be configured from a plastic material. At least one further component of the coupling 16, preferably the internally toothed coupling element 16b, 16c, may be configured from a plastic material, but can also fundamentally be configured from metal. In one or more embodiments, the drive and/or output shaft 7a, 7b and/or the at least one gearwheel 17a or 17b, as an example the two gearwheels 17a, 17b, and/or the internal gear 17c and/or the shaft attachment 17d can be configured from metal or from a plastic material. In one or more embodiments, it is the case in the two exemplary embodiments that the externally toothed coupling elements 16a, 16b (FIG. 5) or 16a (FIG. 6) (here, therefore the gearwheels 17a, 17b) are configured in each case from metal, and the internally toothed coupling elements 16c (FIG. 5) and 16b (FIG. 6) (here, therefore the internal gear 17c and the shaft attachment 17d) are configured from a plastic material.

In one or more embodiments, at least one gearwheel 17a, 17b or the two gearwheels 17a, 17b is/are of convex configuration, in relation to an axial section, to be precise here with a convex toothed tip surface (tooth tip convex) and, as an example, also convex tooth flank (crowned), but can also be of conical configuration, at any rate in sections. This also applies accordingly to the case where, instead of a gearwheel 17a, 17b, an externally toothed shaft end portion is provided as externally tooth coupling element 16a, 16b, which externally toothed shaft end portion can then also be tooth tip convex and, as an example, crowned and/or conical, at any rate in sections. “Convex” means that the radially outwardly pointing tooth tip surface of the teeth or the right-hand and/or left-hand tooth flank of the teeth is curved in each case about an axis which is orthogonal with respect to the rotational axis. “Conical” means that the tooth edges are inclined with respect to the rotational axis here. A convex form of the teeth on the tooth tip surface can be seen, for example, in the axial section of FIGS. 5 and 6.

In addition or as an alternative, the internal gear 17c or the shaft attachment 17d are preferably of straight configuration radially on the inner side, in relation to an axial section, that is to say the radially inwardly pointing tooth edges of the teeth run parallel to the rotational axis. It is also conceivable that, in relation to an axial section, the internal gear 17c or the shaft attachment 17d is of conical configuration radially on the inner side, at any rate in sections, that is to say the radially inwardly pointing tooth edges of the teeth are inclined with respect to the rotational axis in this region. The tooth edges of the internal gear 17c or shaft attachment 17d are at least at any rate not curved and/or conical to the same extent as the radially outwardly pointing tooth edges of the teeth of the respective externally toothed gearwheel 17a, 17b. In this way, at least an angular offset (FIG. 5c) and FIG. 6b)) and possibly also an axial offset (FIG. 5b)) can be compensated for.

In the case of the exemplary embodiments which are shown and to this extent are preferred, it is provided, furthermore, that, as has already been indicated, the drive shaft 7a, to which the first coupling element 16a is connected fixedly for conjoint rotation, is a shaft of the motor unit 6 (here and preferably, the motor shaft), but can fundamentally also be a gear mechanism output shaft of an intermediate gear mechanism of the motor unit 6. An intermediate gear mechanism of this type is then, as an example, coupled to the motor shaft in drive terms.

In the case of the exemplary embodiments, the output shaft 7b, to which the second coupling element 16b is connected fixedly for conjoint rotation, is also a shaft of the motor unit 6. The output shaft 7b is, by way of example here, the shaft which supports the worm 12 of the worm gear stage 11. Here, this shaft 7b is assembled by way of radial bearings 18, as an example combined radial/axial bearings.

In accordance with another embodiment (not shown here), however, the output shaft 7b can also fundamentally be a shaft of the advancing mechanism 8. As has already been described above, the advancing mechanism 8 is, here and preferably, a spindle/spindle nut mechanism with a spindle 9 and a spindle nut 10 which is in meshing engagement with it for generating drive movements along the spindle axis which corresponds to the geometric advancing mechanism axis X. It is therefore also conceivable that the output shaft 7b, to which the second coupling element 16b is connected fixedly for conjoint rotation, is the spindle 9 of the advancing mechanism 8.

FIG. 4 finally also shows that the drive housing 15 of the drive 5 receives, here and preferably, the motor unit 6 and/or the advancing mechanism 8 and/or one or more of the coupling elements 16a, 16b, 16c, preferably the entire coupling 16. The drive housing 15 may be configured in such a way that it for the greatest part or completely surrounds the motor unit 6 and/or the advancing mechanism 8 and/or one or more of the coupling elements 16a, 16b, 16c, preferably the entire coupling 16.

In accordance with a further teaching which is given independent significance, an adjusting element arrangement 20 with an adjusting element 2, as an example a closing element, of a motor vehicle and with a drive arrangement 1 according to the proposal is claimed. Reference may be made to all the comments with respect to the drive arrangement 1 according to the proposal.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMBERS

1 drive arrangement

2 element

3 motion link

4 drive unit

5 drive

6 motor unit

8 mechanism

9 spindle

10 spindle nut

11 worm gear stage

12 worm

13 worm gear

15 drive housing

16 coupling

17 curved tooth coupling

18 radial bearings

19 circumferential inner collar

7a output shaft

7b drive shaft

14a drive connector

14b drive connector

16a coupling elements

16b second coupling element

16c third coupling element

17a gearwheel

17b gearwheels

17c internal gear

17d shaft attachment

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A drive arrangement for motorized adjustment of an adjusting element of a motor vehicle, the drive arrangement comprising:
the drive arrangement including a drive unit provided with a drive including,
a motor unit configured to rotate,
an advancing mechanism connected downstream of the motor unit in drive terms and configured to generate drive movements along a geometric advancing mechanism axis in a first adjusting direction and a second adjusting direction,
a coupling including a plurality of coupling elements wherein a first coupling element of the plurality of coupling elements is fixedly connected to a drive shaft of the drive for conjoint rotation of the first coupling unit and the drive shaft and a second coupling element of the plurality of coupling elements is fixedly connected to an output shaft of the drive for conjoint rotation of the second coupling element and the output shaft, wherein the plurality of coupling elements are configured to operate in a coupled state, in which the plurality of coupling elements are coupled to one another in drive terms to transmit rotational movements from the drive shaft to the output shaft, the rotational movements generate the drive movements of the advancing mechanism,
wherein the coupling is formed as a curved tooth coupling.

2. The drive arrangement of claim 1, wherein the first coupling element and the second coupling element are each externally toothed, and a third coupling element of the plurality of coupling elements is internally toothed, when the third coupling element is in an assembled state, the third coupling element is configured to come into torque-transmitting engagement with the first coupling element and then the second coupling element.

3. The drive arrangement of claim 1, wherein the first coupling element is externally toothed and the second coupling element is internally toothed, or vice-versa, and wherein in an assembled state, the first coupling element is in torque-transmitting engagement or configured to come into torque-transmitting engagement during operation of the drive arrangement with the second coupling element.

4. The drive arrangement of claim 1, wherein the first coupling element and the second coupling element are each externally toothed, at least one of the first and second coupling elements is a gearwheel disposed on at least one of the drive shaft and the output shaft, or wherein at least one of the drive shaft and the output shaft includes an externally toothed shaft end portion.

5. The drive arrangement of claim 1, wherein the plurality of coupling elements includes an internally toothed coupling element and two externally toothed coupling elements, the internally toothed coupling element radially surrounding the two externally toothed coupling elements,
wherein the internally toothed coupling element is formed by,
an internally toothed internal gear,
an internally toothed shaft attachment disposed on at least one of the drive shaft and the output shaft, or
an internally toothed hollow shaft-shaped shaft end portion of at least one of the drive shaft and the output shaft.

6. The drive arrangement of claim 1, wherein the first coupling element and the second coupling element are each externally toothed and at least one of the first and second coupling elements are formed of metal or plastic material, and/or an internally toothed coupling element of the plurality of coupling elements is formed of metal or a plastic material.

7. The drive arrangement of claim 1, wherein the plurality of coupling elements includes at least one gearwheel, the at least one gearwheel is convex with respect to an axial section of the at least one gearwheel.

8. The drive arrangement of claim 1, wherein the drive shaft forms a portion of the motor unit.

9. The drive arrangement of claim 1, wherein the output shaft forms a portion of the motor unit or the advancing mechanism.

10. The drive arrangement of claim 1, wherein the advancing mechanism includes a spindle/spindle nut mechanism provided with a spindle and a spindle nut, the spindle and the spindle nut are in meshing engagement with one another and configured to generate the drive movements along a spindle axis corresponding to the geometric advancing mechanism axis.

11. The drive arrangement of claim 1, wherein the output shaft, to which the second coupling element is connected fixedly for conjoint rotation, is the spindle of the advancing mechanism.

12. The drive arrangement of claim 1, further comprising:
a worm gear stage operatively connected between the motor unit and the advancing mechanism is provided, the worm gear stage provided with a worm and a worm gear in meshing engagement with the worm.

13. The drive arrangement of claim 1, wherein the output shaft is configured to support the worm.

14. The drive arrangement of claim 1, wherein the drive includes a drive housing, the drive housing receives at least one of the motor unit, the advancing mechanism, and one or more of the plurality of coupling elements.

15. An adjusting element arrangement provided with an adjusting element of a motor vehicle and the drive arrangement of claim 1.

16. The drive arrangement of claim 7, wherein the at least one gearwheel includes an external tooth, and a tip of the external tooth is convex with respect to the axial section.

17. The drive arrangement of claim 16, wherein the external tooth is crowned with respect to the axial section.

18. The drive arrangement of claim 1, wherein at least one of the drive shaft and the output shaft include an internal gear provided with an internal tooth, the internal tooth is not convex with respect to an axial section of the internal gear.

19. A drive arrangement configured to provide motorized adjustment of an adjusting element of a motor vehicle, the drive arrangement comprising:
a drive mechanism provided with a spindle and a worm wheel operatively coupled to the spindle;
a motor provided with an drive shaft;
an output shaft, the drive shaft and the output shaft configured to extend along an axis;
a worm coupled to the output shaft, the worm configured to rotate to drive the worm wheel to translate the spindle and provide the motorized adjustment;
a first externally toothed coupling element fixed to the drive shaft; and
an internally tooth coupling element coupled to the output shaft and the first externally toothed coupling element, wherein the first externally toothed coupling element and the internally toothed coupling element are conjointly figured to tilt with respect to one another and with respect the axis.

20. The drive arrangement of claim 19, further comprising:
a second externally toothed coupling element fixed to output shaft, wherein the internally toothed coupling element radially surrounds the first and second externally toothed coupling elements.
